(19) United States
(12) Patent Application Publication
(10) Pub. No.: US 2025/0350685 A1
(43) Pub. Date: Nov. 13, 2025

(54) INFORMATION PROCESSING DEVICE, CONFERENCE SYSTEM, AND INFORMATION PROCESSING METHOD

(71) Applicant: Sharp NEC Display Solutions, Ltd., Tokyo (JP)

(72) Inventor: Michio TOMIZAWA, Tokyo (JP)

(21) Appl. No.: 19/278,099

(22) Filed: Jul. 23, 2025

Related U.S. Application Data
(63) Continuation of application No. PCT/JP2023/034125, filed on Sep. 20, 2023.

(51) Int. Cl. H04M 3/56

(52) U.S. Cl. CPC H04M 3/568; H04M 3/563

(57) ABSTRACT

An information processing device includes a first determination unit to compare between audio levels of audio data based on speech contents transmitted from at least two different information processing devices other than the information processing device and a determination target; a selection unit to select an information processing terminal on the basis of the determination result; a first transmission unit to transmit an evaluation result to the selected information processing terminal; a first reception unit to receive the evaluation result from different information processing devices other than the information processing device; and a second determination unit to determine whether there is a cause the audio level has not reached the criterion in the information processing device or a different information processing device which is a source of the evaluation result on the basis of the received evaluation result. The information processing device outputs a notification based on the determination result.

### TECHNICAL FIELD

The present invention relates to an information processing device, a conference system, and an information processing method.

### BACKGROUND ART

There is an online conference system to which a plurality of terminal devices are communicatively connected and which transmits audio data based on speech contents of a speaker from one terminal device to another terminal device. In such an online conference system, two terminal devices may be connected or three terminal devices may be connected.

Patent Document 1 discloses a teleconference system in which a plurality of participants belong to the same conference room and have a teleconference.

### CITATION LIST

### Patent Document

Patent Document 1: Japanese Unexamined Patent Application, First Publication No. 2017-063416

### SUMMARY OF INVENTION

### Technical Problem

When a user participates in an online conference using such an online conference system, it may be hard to hear speech based on audio data transmitted from a terminal device of a certain speaker. A cause it is hard to hear speech is that an audio level of the audio data is low or that much noise is included in the audio data. The causes for this may lie on a transmitting side of the audio data or on a receiving side, and it may be difficult to identify on what side the cause lies.

In Patent Document 1, a user can ascertain whether information output from a terminal device of the user has been appropriately transmitted to a communication partner, but there is a period in which no participant speaks in an online conference. In this case, it cannot be ascertained whether speech based on audio data can be heard.

### Solution to Problem

According to an aspect of the present invention, there is provided an information processing device that is a self-information processing device used by a participant and operates in a conference system to which the information processing device is communicatively connected, the information processing device including: a first determination unit configured to determine an audio level of audio data based on speech contents which are transmitted from at least two information processing devices other than the self-information processing device; a selection unit configured to select an information processing terminal which is a source of audio data of which the audio level has not reached a criterion on the basis of the result of determination; a first transmission unit configured to transmit an evaluation result indicating that the audio level has not reached the criterion to the selected information processing terminal; a first reception unit configured to receive the evaluation result from information processing devices other than the self-information processing device; a second determination unit configured to determine whether there is a cause the audio level has not reached the criterion in the self-information processing device or an information processing device which is a source of the evaluation result on the basis of the received evaluation result; and an output unit configured to notify a notification indicating that there is a cause in the self-information processing device to the self-information processing device when it is determined on the basis of the result of determination from the second determination unit that there is a cause in the self-information processing device.

According to another aspect of the present invention, there is provided an information processing device that is a self-information processing device used by a participant and operates in a conference system to which the information processing device is communicatively connected, the information processing device including: a speech output unit configured to output speech according to audio data based on speech contents which are transmitted from at least two information processing devices other than the self-information processing device; an instruction input unit configured to receive an instruction indicating sound hard to hear due to a lower audio level of audio data than that of other information processing devices out of speech output from the speech output unit and an instruction indicating which of the information processing devices a source of the speech hard to hear is; a selection unit configured to select an information processing terminal which is the source of the speech hard to hear on the basis of the received instructions; a first transmission unit configured to transmit an evaluation result indicating that speech is hard to hear to the selected information processing terminal; a first reception unit configured to receive the evaluation result from an information processing device other than the self-information processing device; a second determination unit configured to determine whether there is a cause the speech is hard to hear in the self-information processing device or the information processing device which is a source of the evaluation result on the basis of the received evaluation result; and an output unit configured to notify a notification indicating that there is a cause in the self-information processing device to the self-information processing device when it is determined on the basis of the result of determination from the second determination unit that there is a cause in the self-information processing device.

According to another aspect of the present invention, there is provided a conference system to which an information processing device used by a participant is communicatively connected, the conference system including: a first determination unit configured to determine an audio level of audio data based on speech contents which are transmitted from at least two information processing devices other than a first information processing device; a selection unit configured to select an information processing terminal which is a source of audio data of which the audio level has not reached a criterion on the basis of the result of determination; a first transmission unit configured to transmit an evaluation result indicating that the audio level has not reached the criterion to the selected information processing terminal; a first reception unit configured to receive the evaluation result from information processing devices other than the first information processing device; a second determination unit configured to determine whether there is a cause the audio level has not reached the criterion in the first information processing device or an information processing device which is a source of the evaluation result on the basis of the received evaluation result; and an output unit configured to notify a notification indicating that there is a cause in the first information processing device to the first information processing device when it is determined on the basis of the result of determination from the second determination unit that there is a cause in the first information processing device.

According to another aspect of the present invention, there is provided an information processing method in a conference system to which an information processing device used by a participant is communicatively connected, the information processing method including: a first determination step of determining an audio level of audio data based on speech contents which are transmitted from at least two information processing devices other than a first information processing device; a selection step of selecting an information processing terminal which is a source of audio data of which the audio level has not reached a criterion on the basis of the result of determination; a first transmission step of transmitting an evaluation result indicating that the audio level has not reached the criterion to the selected information processing terminal; a first reception step of receiving the evaluation result from information processing devices other than the first information processing device; a second determination step of determining whether there is a cause the audio level has not reached the criterion in the first information processing device or an information processing device which is a source of the evaluation result on the basis of the received evaluation result; and an output step of outputting a notification indicating that there is a cause in the first information processing device to the first information processing device when it is determined on the basis of the result of determination in the second determination step that there is a cause in the first information processing device.

### Advantageous Effects of Invention

It is possible to select a terminal device in which there is a likelihood that a cause an audio level is low lies out of information processing devices of participants participating in an online conference system.

### BRIEF DESCRIPTION OF DRAWINGS

FIG. 1 A system configuration diagram schematically illustrating a configuration of an audio adjustment support system S in an online conference.

FIG. 2 A functional block diagram schematically illustrating functions of a terminal device.

FIG. 3 A flowchart illustrating operations of a terminal device participating in an online conference of an online conference system S.

FIG. 4A A diagram illustrating an example of an audio level of audio data received from a terminal device 12.

FIG. 4B A diagram illustrating an example of an audio level of audio data received from a terminal device 13.

FIG. 5 A diagram illustrating an example in which feedback is transmitted.

FIG. 6 A flowchart illustrating operations of a terminal device when feedback is received.

FIG. 7 A diagram illustrating an example of a dialogue screen.

FIG. 8 A diagram illustrating operations of a terminal device having received a response signal with respect to feedback from another terminal device.

FIG. 9 A diagram illustrating an example of a dialogue screen.

FIG. 10 A system configuration diagram illustrating a configuration of an online conference system Sa according to a second embodiment.

FIG. 11 A flowchart illustrating a process of selecting a destination of feedback.

FIG. 12 A diagram illustrating an audio level of audio data.

FIG. 13 A functional block diagram schematically illustrating a configuration of a terminal device that is used in an online conference system according to a third embodiment.

FIG. 14 A flowchart illustrating operations of a terminal device.

FIG. 15 A diagram illustrating an example of a display screen that is displayed on an output unit 108 of a terminal device 11a.

FIG. 16 A functional block diagram schematically illustrating a configuration of an information processing device 11b that is used in an online conference system according to a fourth embodiment.

### DESCRIPTION OF EMBODIMENTS

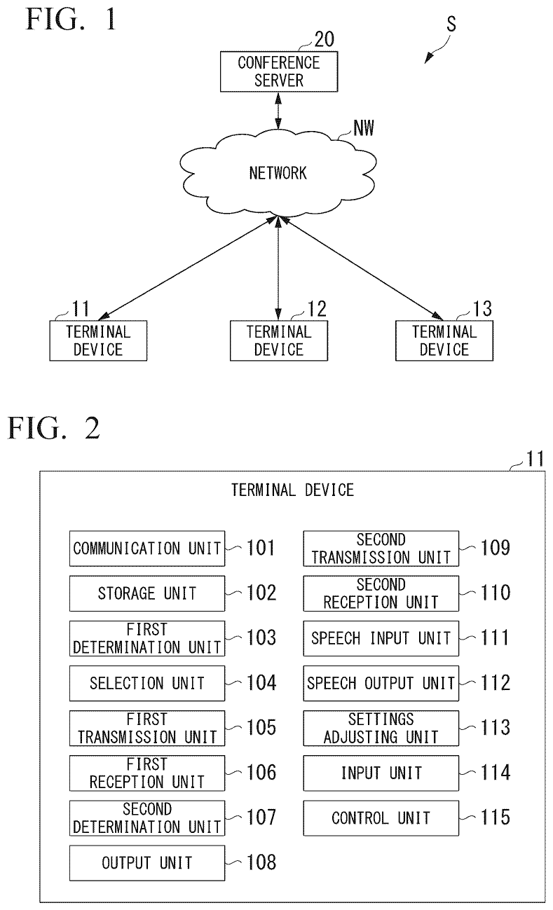

FIG. 1 is a system configuration diagram schematically illustrating a configuration of an audio adjustment support system S in an online conference system. FIG. 1 illustrates an example in which three terminal devices including a terminal device 11, a terminal device 12, and a terminal device 13 participate in an online conference in the same conference room in an online conference system S.

In the online conference system S, a plurality of terminal devices are communicatively connected to a conference server 20 via a network NW. Here, three terminal devices including a terminal device 11, a terminal device 12, and a terminal device 13 are connected as the plurality of terminal devices. The terminal device 11, the terminal device 12, and the terminal device 13 are used by different users. Here, it is assumed that devices participating in an online conference are terminal devices, but devices participating in an online conference may not have a form of a terminal device as long as they are information processing devices. In this case, the information processing devices have the same function as the terminal devices.

The conference server 20 transmits audio data based on speech contents from participants to a plurality of terminal devices of which participation is permitted by permitting participation in an online conference in response to a participation request which is transmitted from each terminal device according to an operation input from each participant participating in the online conference. Accordingly, speech contents of a participant are transmitted to the terminal devices of the other participants, and audio data is reproduced, whereby the online conference is held.

The terminal device 11, the terminal device 12, and the terminal device 13 are used by different participants. For example, the terminal device 11 is used by participant A, the terminal device 12 is used by participant B, and the terminal device 13 is used by participant C.

FIG. 2 is a functional block diagram schematically illustrating functions of a terminal device. Here, the functions of the terminal device 11 will be described, and the other terminal devices (the terminal device 12 and the terminal device 13) have the same functions.

A communication unit 101 is communicatively connected to the conference server 20 via a network NW. The communication unit 101 transmits audio data based on speech input from a speech input unit 111 of a self-terminal device (for example, the terminal device 11) to the conference server 20 via the network NW and receives audio data generated by another terminal device and transmitted from the conference server 20. The communication unit 101 transmits a notification (for example, a message) generated by the self-terminal device (for example, the terminal device 11) to the conference server 20 via the network NW and receives a message generated by another terminal device and transmitted from the conference server 20.

A storage unit 102 stores various types of data. For example, the storage unit 202 stores audio levels of audio data transmitted from terminal devices other than the self-terminal device. Here, the storage unit 102 may store audio data instead of the audio levels.

A first determination unit 103 makes a comparison between audio levels of audio data based on speech contents transmitted from at least two terminal devices other than the self-terminal device and a determination criterion.

The audio level is a value corresponding to a magnitude of the amplitude of speech indicated by audio data. For example, a sound volume of speech indicated by audio data becomes larger as the audio level becomes higher, and the sound volume of speech indicated by audio data becomes smaller as the audio level becomes lower. The audio level may be generated on the basis of audio data by the first determination unit 103 or may be generated on the basis of audio data by a control unit 115.

As the determination criterion, an arbitrary criterion can be used as long as a difference in audio level of audio data transmitted from at least two terminal devices other than the self-terminal device therebetween can be ascertained.

### <Determination Method>

For example, one of (1) and (2) described below may be used as the determination criterion.

(1) On the basis of audio levels of audio data received from at least two terminal devices other than the self-terminal device (for example, the terminal device 11), the first determination unit 103 calculates a difference between the audio levels of audio data transmitted from different terminal devices out of the received audio data. In other words, the difference in audio level is calculated for each combination of terminal devices participating in the same conference room as the conference room of an online conference in which the self-terminal device (for example, the terminal device 11) participates.

The first determination unit 103 makes a comparison between the calculated difference and a reference value. The reference value may be a predetermined value or may employ a value transmitted as a reference value from the conference server 20.

When the difference between the audio levels is greater than the reference value, the audio level of the terminal device with a lowest average value of the audio level in a combination of the terminal devices of which the difference has been calculated can be determined to be separated from those of the terminal devices participating in the online conference.

(2) The first determination unit 103 makes a comparison between the audio levels of the audio data transmitted from at least two information processing devices other than the self-terminal device (for example, the terminal device 11) and a predetermined reference value. In other words, the first determination unit 103 makes a comparison between the audio levels of the audio data transmitted from the terminal devices participating in the same conference room as the conference room of the online conference in which the self-terminal device (for example, the terminal device 11) participates and the reference value. The reference value may be a predetermined value. The reference value may be stored in a storage unit 202, and the first determination unit 103 may read the reference value stored in the storage unit 202 and make a comparison between the reference value and the audio levels.

### <Determination Period>

The first determination unit 103 makes a comparison between the audio levels of audio data based on speech contents. The comparison may be made on the basis of audio data received in an evaluation period. The evaluation period is a fixed time in the past from a determination timing. The determination timing may be the present time. The fixed time in the past may be a predetermined time (for example, 5 minutes). For example, the first determination unit 103 makes a comparison between the audio levels of audio data acquired in 5 minutes in the past from the present time. When the fixed time before the present time is used as a determination period, it is possible to make a comparison even in a situation in which the audio level is maintained at a certain height at a time point at which the online conference has started and then the audio level is lowered with the elapse of time.

Here, the determination timing is the present time, but a timing after the online conference has started and before the present time such as 10 minutes in the past may be used as the determination timing. For example, when the first determination unit 103 makes the comparison with 10 minutes to 20 minutes in the past from the present time as the determination period, the comparison can be performed on participants who have spoken a little while ago and then do not speak.

### <Audio Level Used for Determination>

The first determination unit 103 calculates an average value of audio levels of audio data based on speech contents in a predetermined period in the past for each source of audio data and makes a comparison using the calculated average value. The first determination unit 103 calculates an average value of audio levels of audio data received in a determination period for each source. The first determination unit 103 makes a comparison between the calculated average value and an average value which is calculated on the basis of the audio levels of audio data transmitted from other terminal devices. Here, an example in which an average value is used to make a comparison has been described above, but a peak value of absolute values of the audio levels of audio data acquired in the determination period may be used.

A selection unit 104 selects a terminal device which is a source of audio data of which the audio level has not reached a criterion on the basis of the determination result. The determination criterion for determining whether the audio level reaches a criterion may be a determination criterion for determining whether the audio level is lower from some terminal devices out of a plurality of terminal devices other than the self-terminal device. For example, determination criteria (A) and (B) may be used.

(A) The selection unit 104 selects a terminal device which is a source of audio data of which the audio level is lower as a destination in a combination in which a difference in audio level based on the comparison result is equal to or greater than a reference value on the basis of the result of determination based on the determination criterion described in (1).

(B) The selection unit 104 selects a terminal device which is a source of audio data of which the audio level is determined to be lower than the reference value as a destination on the basis of the comparison result based on the determination criterion described in (2).

A first transmission unit 105 transmits an evaluation result to the terminal device selected by the selection unit 104. The evaluation result is an evaluation result indicating a terminal device in which the audio level of audio data is lower than those of other terminal devices out of terminal devices belonging to the same conference room in the online conference system.

A first reception unit 106 receives an evaluation result indicating that the audio level has not reached a criterion from information terminal devices other than the self-terminal device. That is, the process of acquiring an evaluation result is performed by each terminal device participating in the same conference room of the online conference in addition to the self-terminal device, and the terminal device having acquired the evaluation result transmits the evaluation result to the other terminal devices. Accordingly, for example, the first reception unit 106 of the terminal device (for example, the terminal device 11) receives the evaluation results from the terminal device 12 and the terminal device 13.

A second determination unit 107 determines whether there is a cause the audio level has not reached a criterion in the self-terminal device or a terminal device which is a source of an evaluation result on the basis of the received evaluation results.

When it is determined that there is a cause in the self-terminal device on the basis of the determination result from the second determination unit 107, an output unit 108 outputs a notification (for example, a message) indicating that there is a cause in the self-terminal device to the self-terminal device. The output unit 108 may be a display panel such as a liquid crystal panel or an output circuit that outputs a video signal for displaying a display screen on a display device.

By outputting such a message, a user of the terminal device can ascertain that there is a likelihood that a sound output function of a terminal device used by the user has a cause a situation in which speech of another participant in an online conference is hard to hear occurs. Accordingly, the user can perform various countermeasures such as changing settings associated with outputting of sound or ascertaining a defect of a headset when the headset is used.

When it is determined that there is a cause in the self-terminal device on the basis of the determination result from the second determination unit 107, a second transmission unit 109 transmits a message indicating that there is a cause in the terminal device which is a source of the evaluation result to the terminal device which is a source.

A second reception unit 110 receives a message transmitted from terminal devices other than the self-terminal device. When a message is received by the second reception unit 110, the output unit 108 outputs a message indicating that there is a cause in a sound collecting function of the self-terminal device on the basis of the received messages. By outputting such a message, a user of a terminal device can ascertain that there is a likelihood that a sound collecting function of a terminal device used by the user has a cause a situation in which speech of another participant in an online conference is hard to hear occurs. Accordingly, the user can perform various countermeasures such as changing settings associated with the sound collecting function or ascertaining a defect in a microphone connection state.

The speech input unit 111 receives an input of speech of a participant participating in an online conference using a self-terminal device. The speech input unit 111 may be a microphone. The speech input unit 111 may acquire an analog signal or a digital signal which is generated when spoken sound is detected by the microphone.

A speech output unit 112 outputs speech based on audio data. The speech output unit 112 may be, for example, a speaker. The speech output unit 112 may be a drive circuit of a speaker for outputting an audio signal based on audio data to the speaker.

For example, the speech output unit 112 outputs speech corresponding to audio data based on speech contents transmitted from at least two information processing devices other than the self-terminal device.

A settings adjusting unit 113 sets various settings associated with speech input from the speech input unit 111. The settings adjusting unit 113 sets various settings associated with speech output from the speech output unit 112.

An input unit 114 receives various operation inputs from a user. The input unit 114 may be, for example, at least one of input devices such as a keyboard, a mouse, and a touch panel. The input unit 114 may acquire operation details input to an input device from the input device.

A control unit 115 controls constituents in the self-terminal device.

### «Operations»

Operations of the online conference system S will be described below.

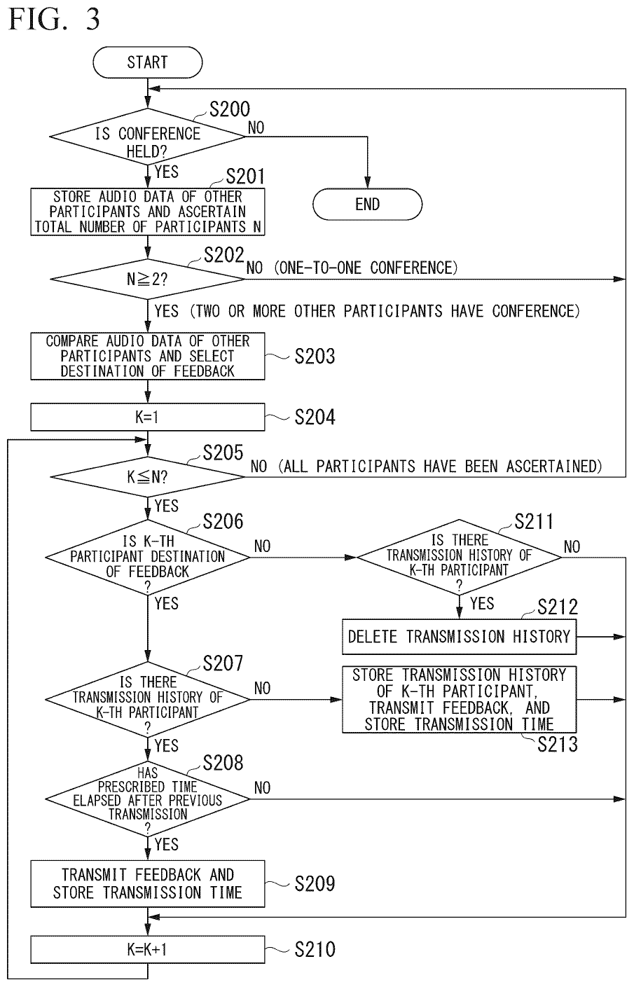

FIG. 3 is a flowchart illustrating operations of a terminal device participating in an online conference of the online conference system S.

Here, it is assumed as illustrated in FIG. 1 that three participants (participant A, participant B, and participant C) participate in the online conference using different terminal devices. Here, operations of the terminal device 11 out of three terminal devices (the terminal device 11, the terminal device 12, and the terminal device 13) will be described as an example, and each of the terminal device 12 and the terminal device 13 performs the same processes as the terminal device 11 with respect to the terminal devices other than the self-terminal device.

When an instruction to participate in an online conference is input to the input unit 114 from participant A, the control unit 115 of the terminal device 11 transmits a request signal for participation in the online conference to the conference server 20 via the communication unit 101. Here, the terminal device 12 and the terminal device 13 also transmit a request signal for participation in the same conference to the conference server 20. The conference server 20 communicatively connects there terminal devices including the terminal device 11, the terminal device 12, and the terminal device 13 to belong to the same conference room. Accordingly, the terminal device 11, the terminal device 12, and the terminal device 13 can perform transmission and reception of audio data each other and have conversations among them.

The control unit 115 of the terminal device 11 determines whether an online conference is held (whether it participates in an online conference) (Step S200). The control unit 115 causes the process flow to proceed to Step S201 when an online conference is held (YES in Step S200), and ends the process flow when an online conference is not held (NO in Step S200).

When an online conference is held (it participates in the online conference), the control unit 115 of the terminal device 11 receives audio data transmitted from the terminal devices (the terminal device 12 and the terminal device 13 here) of participants other than the self-terminal device 11 participating in the online conference via the communication unit 101 and stores the received audio data in the storage unit 102. The control unit 115 counts the number of terminal devices participating in the online conference in which the self-terminal device 11 currently participates (S201). The control unit 115 substitutes the count result into a variable N.

The control unit 115 determines whether the number of terminal devices connected is equal to or greater than 2 (Step S202) and causes the process flow to proceed to Step S200 when the number of terminal devices is less than 2 (NO in Step S202). In this case, since the online conference is performed in a one-to-one manner, that is, between the self-terminal device 11 and another terminal device, a process of evaluating speech may not be performed.

When the number of terminal devices participating except the self-terminal device 11 is equal to or greater than 2 (YES in Step S202), the first determination unit 103 generates an audio level of audio data stored in Step S201 for each terminal device which is a source of the audio data.

Here, numbers are assigned to the terminal devices. For example, the conference server 20 assigns numbers to the terminal devices in the order of receiving a connection request for an online conference, generates a list indicating correspondence between identification information of the participating terminal devices and the assigned numbers, and transmits the list to the terminal devices. Each terminal device can identify a relationship between the numbers assigned to the terminal devices and the terminal devices connected to the online conference with reference to the list.

The first determination unit 103 stores audio levels in correlation with the numbers assigned to the corresponding terminal devices.

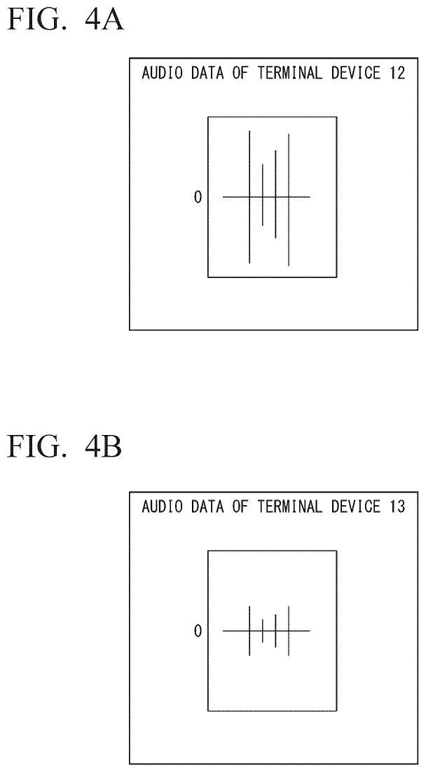

FIG. 4 is a diagram illustrating an example of audio levels of audio data. FIG. 4A is a diagram illustrating an example of an audio level of audio data received from the terminal device 12, and FIG. 4B is a diagram illustrating an example of an audio level of audio data received from the terminal device 13.

In FIGS. 4A and 4B, the horizontal axis represents time, and the vertical axis represents an audio level. Here, audio levels belonging to a determination period which is a predetermined time in the past (5 minutes in the past) from a determination timing (for example, the present time) are illustrated.

The first determination unit 103 calculates an average value in an evaluation period which is the determination period for each terminal device. Here, the first determination unit 103 calculates an average value of the audio level of the audio data acquired in the evaluation period out of audio data acquired from the terminal device 12. The first determination unit 103 calculates an average value of the audio level of audio data acquired in the evaluation period out of audio data acquired from the terminal device 13. Then, the first determination unit 103 calculates a difference between the average value of the audio level calculated on the basis of the audio data from the terminal device 12 and the average value of the audio level calculated on the basis of the audio data from the terminal device 13 and determines whether the value of the difference is greater than a predetermined reference value.

The selection unit 104 identifies a combination of terminal devices in which the difference in audio level is greater than the reference value on the basis of the determination result from the first determination unit 103 and identifies a terminal device in which the average value of the audio level is lower than the average value of the audio level of the other terminal device in the identified combination. Then, the selection unit 104 selects the identified terminal device as a destination of feedback (Step S203). The selection unit 104 stores a number of the selected terminal device and data (for example, a flag) indicating that the terminal device is selected as a destination of the feedback in the storage unit 102.

When there are a plurality of combinations of terminal devices, the terminal device 11 makes a comparison between the average of the audio levels and the reference value for each combination of the terminal devices. Then, the terminal device 11 selects a destination of the feedback on the basis of the comparison result.

Since the selected terminal device has a lower audio level of audio data than those of the other terminal devices, there is a likelihood that it will be hard to hear speech.

Then, the control unit 115 sets a variable K to 1 (Step S204) and determines whether the value of the variable K is equal to or less than N which is the total number of terminal devices (Step S205). When the value of K is not equal to or less than N (NO in Step S205), that is, when the value of K is greater than the value of N, the control unit 115 causes the process flow to proceed to Step S200.

On the other hand, when the value of K is equal to or less than the value of N (YES in Step S205), the control unit 115 determines whether a K-th terminal device is selected as a destination of the feedback (Step S206). For example, when the value of K is 1, the control unit 115 determines whether the terminal device having 1 assigned thereto is selected as a destination of the feedback. The feedback is a signal indicating a request for demanding improvement of speech settings.

When the K-th terminal device is selected as a destination (YES in Step S206), the control unit 115 determines whether the K-th terminal device has a history in which it has transmitted the feedback in the past in the online conference which is currently held (Step S207). Regarding the history indicating that the feedback has been transmitted, the control unit 115 stores a number of a terminal device which is a destination, information (for example, a flag) indicating that the feedback has been transmitted, and the transmission timing in the storage unit 102 in correlation when the feedback has been transmitted to some terminal devices.

When the feedback has been transmitted to the K-th terminal device (YES in Step S207), the control unit 115 determines whether a prescribed time has elapsed from a timing at which the feedback has been transmitted previously (Step S208). Here, the prescribed time is a predetermined time, for example, 5 minutes.

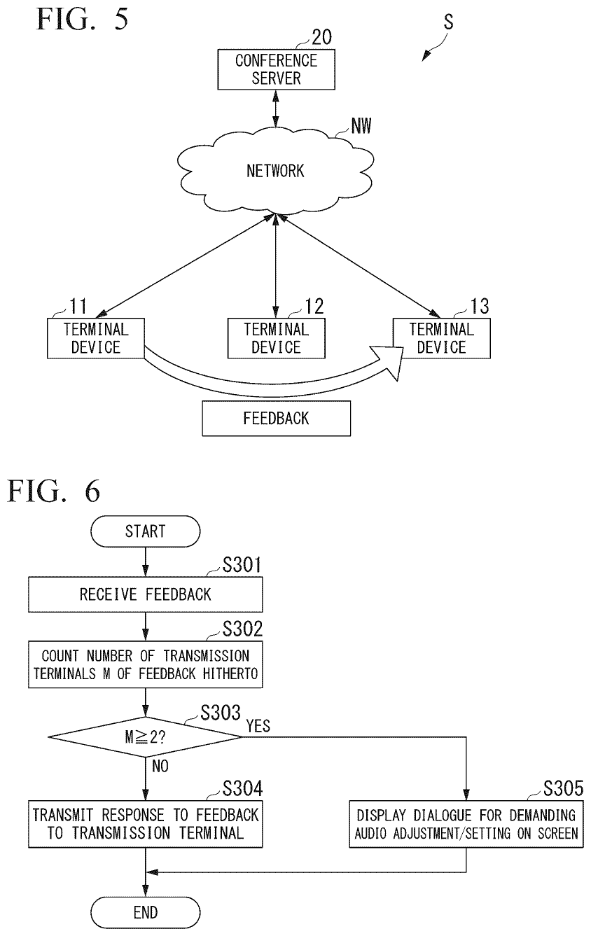

When a prescribed time has elapsed from the timing at which the feedback has been transmitted previously (YES in Step S208), the control unit 115 outputs an instruction to transmit the feedback to the first transmission unit 105. The first transmission unit 105 having received this instruction transmits the feedback to a terminal device which is a destination. For example, when the terminal device 11 determines that the audio level of the terminal device 13 is much lower as a result of comparison in audio level between the terminal devices (the terminal device 12 and the terminal device 13) of the other participants as illustrated in FIG. 5, the terminal device 11 transmits the feedback for demanding improvement of audio settings to the terminal device 13.

When the feedback has been transmitted, the control unit 115 stores the timing at which the feedback has been transmitted and the number assigned to the terminal device which is the destination in the storage unit 102 (Step S209).

Then, the control unit 115 adds 1 to the value of K (Step S210) and causes the process flow to proceed to Step S205. Here, by adding 1 to the value of K, the process flow based on whether a terminal device of a next number is selected as a destination of the feedback can be performed. This process flow can be performed on each of the terminal devices participating in the online conference.

On the other hand, when it is determined in Step S206 that the K-th terminal device is not a destination of the feedback (NO in Step S206), the control unit 115 determines whether there is a history of transmission of the feedback to the K-th terminal device with data stored in the storage unit 102 (Step S211).

When there is no history of transmission of the feedback to the K-th terminal device (NO in Step S211), the control unit 115 causes the process flow to proceed to Step S210. On the other hand, when there is a history of transmission of the feedback, the control unit 115 deletes the transmission history indicating that the feedback has been transmitted to the K-th terminal device (YES in Step S212). Here, when the K-th terminal device is determined not to be a destination of the feedback and a transmission history remains, the transmission history is deleted. Accordingly, when the K-th terminal device has been previously selected as a destination of the feedback and then the audio level has been improved, it is not necessary to select the K-th terminal device as a destination and it is possible to prevent transmission of the feedback thereto.

When it is determined in Step S207 that there is no history of transmission to the K-th terminal device (NO in Step S207), the control unit 115 transmits the feedback to the K-th terminal device and stores information indicating that the feedback has been transmitted to the K-th terminal device and the transmission timing as a transmission history in the storage unit 102 (Step S213).

When it is determined in Step S208 that the prescribed time has not elapsed from the previous transmission (NO in Step S208), the control unit 115 causes the process flow to proceed to Step S210. Here, when there is a transmission history and the prescribed time has not elapsed from the previous transmission timing, it is possible to prevent transmission of the feedback to the corresponding terminal device. Accordingly, it is possible to prevent transmission of the feedback by a plurality of times in a short period.

In the process flow illustrated in FIG. 3, when an audio level of audio data is not equal to or greater than a predetermined level, a destination of the feedback may not be selected for any terminal device. In this case, any terminal device can hear speech based on audio data from all the other terminal devices participating in the online conference.

### <Reception of Feedback>

FIG. 6 is a flowchart illustrating operations of a terminal device when the feedback has been received.

The process flow illustrated in FIG. 6 is performed by a terminal device having received the feedback from a terminal device other than the self-terminal device out of terminal devices participating in the online conference.

Here, it is assumed that the terminal device 13 receives the feedback from at least one of the terminal device 11 and the terminal device 12.

When the feedback has been received (Step S301), the control unit 115 of the terminal device 13 counts the total number M of terminal devices having transmitted the feedback hitherto (Step S302). For example, when the feedback has been received from only the terminal device 11 or only the terminal device 12, the control unit 115 of the terminal device 13 counts the total number M as 1. When the feedback has been received from the terminal device 11 and the terminal device 12, the control unit 115 counts the total number M as 2.

Then, the control unit 115 of the terminal device 13 determines whether the total number M is equal to or greater than 2 (Step S303) and transmits a response signal to the feedback to the terminal device which is a source (Step S304) when the total number M is not equal to or greater than 2 (NO in Step S303), that is, when the total number M is 1. In this case, the terminal device having transmitted the feedback is the terminal device 11 or the terminal device 12, and the other terminal devices have not transmitted the feedback. Accordingly, the control unit 115 of the terminal device 13 can determine that there is a likelihood that the terminal device which is the source of the feedback has a defect and transmit a response signal to the feedback. That is, the terminal device which is a source having transmitted the feedback can be determined to have a cause and can be distinguished.

On the other hand, when it is determined in Step S303 that the total number M is equal to or greater than 2, the control unit 115 displays a dialogue for demanding audio adjustment and setting on a display screen of the self-terminal device 11 (Step S305). In this case, since the feedback is received from the terminal device 12 in addition to the terminal device 11, the terminal device which is a source of audio data (the terminal device 13 herein) can be determined to include a cause and can be distinguished.

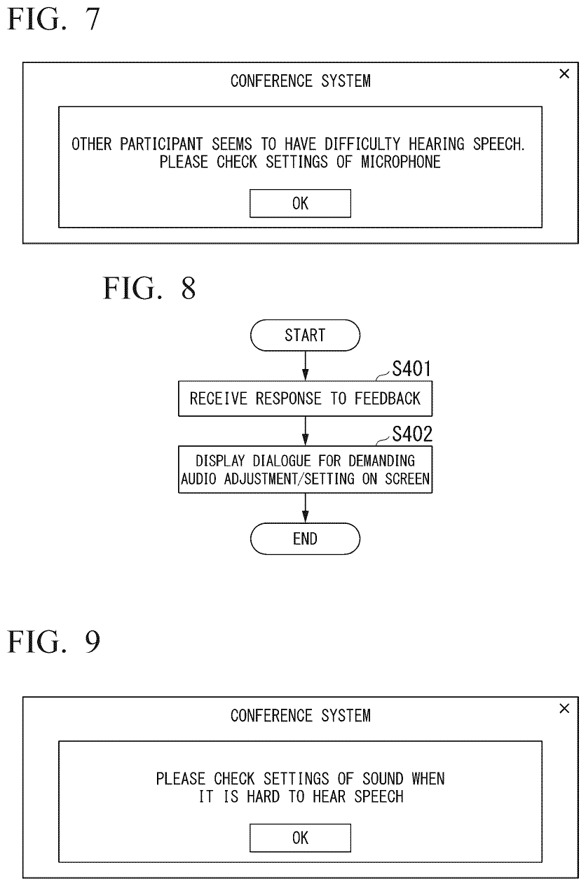

FIG. 7 is a diagram illustrating an example of a dialogue screen displayed through the process of Step S305. As illustrated in this drawing, a state in which another terminal device has difficulty hearing speech based on audio data transmitted from the self-terminal device is displayed on the display screen, and a message for demanding review of settings of a microphone is also displayed. Accordingly, for example, the participant of the terminal device 13 can raise or lower a sound collection level of the microphone by reviewing settings of the microphone of the terminal device 13.

FIG. 8 is a diagram illustrating operations of a terminal device having received a response signal to the feedback from another terminal device. Here, it is assumed that the terminal device 12 has received a response signal to the feedback from the terminal device 13.

When a response signal to the feedback has been received from another terminal device (the terminal device 13), it means that an event in which the feedback is transmitted has not occurred in the terminal device 11 and the terminal device 13. Accordingly, the terminal device 12 needs to review its own settings.

When a response signal to the feedback is received (Step S401), the control unit 115 of the terminal device 12 displays a dialogue screen for demanding audio adjustment and setting to the display screen of the self-terminal device 12 (Step S402). By displaying this dialogue screen, it is possible to present that a sound outputting function of the self-terminal device (the terminal device 12) is poor. Accordingly, the self-terminal device can be determined to include a cause speech is hard to hear and can be distinguished.

FIG. 9 is a diagram illustrating an example of a dialogue screen displayed through the process of Step S402. As illustrated in this drawing, a message (notification) for demanding reviewing of settings of sound of the self-terminal device is displayed on the dialogue screen.

For example, when the feedback has been transmitted from the terminal device 12 to other terminal devices and the terminal devices having transmitted the feedback are only the self-terminal device, it is considered that an audio level of audio data transmitted from the other terminal devices is higher than a predetermined level and there is a cause in settings associated with outputting speech of the self-terminal device 12 or the like. This cause may be, for example, that a sound volume of a speaker is set to be small. This cause may be that a participant cannot hear the speech because an unintended speaker is erroneously selected as an output destination out of a plurality of speakers when the plurality of speakers are connected to the terminal device 12. This cause may be that a headset connected to the self-terminal device 12 and worn by a participant is poor and thus speech is heard at a low audio level when a communication environment between the self-terminal device 12 and the conference server 20 is poor.

In this case, a participant using the terminal device 12 can ascertain a dialogue screen by displaying the dialogue screen on the terminal device 12, and the participant can check various settings associated with outputting of speech from the terminal device 12 again. For example, it is possible to achieve improvement by causing the participant to ascertain or review whether a sound volume of the terminal device 12 is set to be low, whether a speaker selected as an output destination is an intended speaker, and whether a defect such as failure is included in the headset.

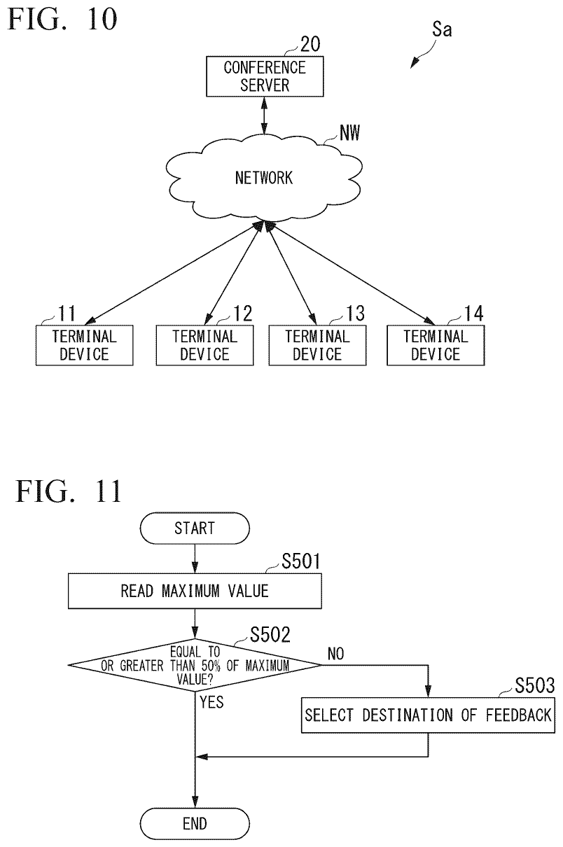

FIG. 10 is a system configuration diagram illustrating a configuration of an online conference system Sa according to a second embodiment. FIG. 10 illustrates an example in which four terminal devices including a terminal device 11, a terminal device 12, a terminal device 13, and a terminal device 14 participate in the same conference room of an online conference in the online conference system Sa. The terminal device 11, the terminal device 12, the terminal device 13, and the terminal device 14 have the same function as the terminal device 11 described above with reference to FIG. 2.

When an online conference starts in a state in which the four terminal devices belong to the same conference room, each terminal device performs the same processes as Steps S200 to S202 in FIG. 3.

Then, in Step S203, the first determination unit 103 in each terminal device makes a comparison between the audio levels of audio data transmitted from the terminal devices and selects a destination of the feedback on the basis of the determination result.

Regarding making of this comparison, a process based on the method (2) in the first determination unit 103 may be performed.

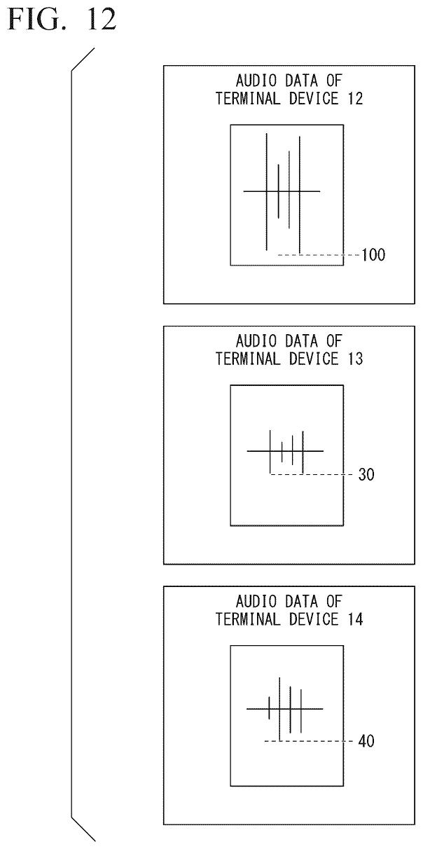

FIG. 11 is a flowchart illustrating a process of selecting a destination of the feedback, and FIG. 12 is a diagram illustrating an example of an audio level of audio data.

The terminal device 11 receives audio data from the terminal device 12, the terminal device 13, and the terminal device 14 and reads a maximum value of the audio level of the audio data (Step S500). The terminal device 11 may acquire data indicating a maximum value by receiving the data from the conference server 20 or may read a maximum value when the maximum value is stored in the storage unit 102 in advance. Here, the maximum value is, for example, 100.

The first determination unit 103 of the terminal device 11 makes a comparison between the audio level of the audio data received from the terminal device and the maximum value.

FIG. 12 is a diagram illustrating an example of an audio level of audio data. For example, it is assumed that a peak value of the audio level of audio data acquired from the terminal device 12 is 100, a peak value of the audio level of audio data acquired from the terminal device 13 is 30, and a peak value of the audio level of audio data acquired from the terminal device 14 is 40.

The first determination unit 103 determines whether a ratio of the peak value to the maximum value is greater than a reference value (Step S502) for each terminal device. Here, the ratio of the peak value to the maximum value is 100% in the terminal device 12, 30% in the terminal device 13, and 40% in the terminal device 14. The first determination unit 103 makes a comparison between these values and a reference value 50%.

Since the first determination unit 103 determines that the ratio in the terminal device 12 is 100% and is greater than the reference value 50% (YES in Step S502), the selection unit 104 does not select the terminal device 12 as a destination of the feedback. On the other hand, since the ratio in the terminal device 13 is 30% and is less than the reference value 50% and the ratio in the terminal device 14 is 40% and is less than the reference value 50% (NO in Step S502), the selection unit 104 selects the terminal device 13 and the terminal device 14 as a destination of the feedback (Step S503).

By performing the processes of Step S204 and steps subsequent thereto in FIG. 3 after the destination of the feedback has been selected in this way, the terminal device in which there is a likelihood that there is a cause speech is hard to hear out of the speech transmission side and the speech reception side can be caused to display a dialogue screen for demanding reviewing of audio adjustment and setting.

The process based on the method (2) in the first determination unit 103 described above in the present embodiment is applied to a case in which the number of terminal devices participating in the online conference is 4, but may be applied to a case in which the number of terminal devices is 3 or a case in which the number of terminal devices is 5 or greater.

According to the aforementioned embodiment, a comparison between the audio levels of a plurality of terminal devices other than the self-terminal device is made. Accordingly, even in a state in which a participant of the self-terminal device does not speak, it is possible to select and display a terminal device on which a dialogue screen is displayed according to a cause a situation in which it is hard to hear speech occurs. As a result, it is possible to improve hearing.

In the aforementioned embodiment, the terminal devices may transmit a participation request for an online conference substantially at the same timing, or at least some terminal devices may transmit a participation request later. For example, a certain terminal device may participate when about 10 minutes has elapsed after the online conference has started. In this case, the process flows illustrated in FIGS. 3, 6, 7, 8, and 11 can also be performed to include the terminal device having participated in the middle. Accordingly, a cause a situation in which it is hard to hear speech occurs can be distinguished to include the terminal device having participated in the middle.

In the aforementioned online conference system S and the aforementioned online conference system Sa, all the terminal devices out of the terminal devices participating in an online conference may transmit audio data with speech from participants thereof in an evaluation period. A terminal device participating in the online conference not transmitting audio data because a participant thereof does not speak in the evaluation period may be included. For example, when the number of participants participating in an online conference is 10 and the participants participate in the online conference using different terminal devices, at least two participants have only to speak in a certain evaluation period. For example, when the number of participants is 6, a cause distinguishing process can be performed on the 6 participants. In this case, when there is a terminal device not having transmitted audio data in the evaluation period, the number obtained by excluding the terminal device from the total number of terminal devices connected to the online conference may be input to the variable N. Accordingly, a terminal device in which there is speech in the evaluation period out of terminal devices participating in the online conference can be included as a target and a terminal device in which there is no speech can be excluded from the target. Making a comparison between the audio levels of audio data and distinguishing a cause can be performed on the terminal devices in which there is speech. In this case, a terminal device not having transmitted audio data can make a comparison between the audio levels of audio data received from the terminal devices other than the self-terminal device and transmit feedback on the basis of the comparison result. Accordingly, even when terminal devices other than the self-terminal device have speech, a terminal device not having transmitted audio data can also resolve a situation in which speech is hard to hear in one terminal device of the other terminal devices.

According to the aforementioned embodiment, when at least two terminal devices out of terminal devices participating in an online conference transmit audio data in an evaluation period, it is possible to ascertain whether speech based on audio data transmitted from the self-terminal device to the other terminal devices is hard to hear in the other terminal devices and to demand changing of settings of speech.

According to the first embodiment and the second embodiment, a participant in the conference system stores the values of the audio levels of audio data received from other terminal devices other than a terminal device which is used by the participant. The terminal device selects a terminal device of which the audio level is lower than the other terminal devices on the basis of a difference in audio level between the other terminal devices and transmits feedback to the selected terminal device. When the feedback is received from a plurality of terminal devices, the terminal device having received the feedback can determine that there is a problem in the self-terminal device and display a dialogue for demanding audio adjustment and setting on a display screen, whereby it is possible to display a message indicating a likelihood that there is a cause in the self-terminal device. On the other hand, when the feedback is received from only one specific terminal device, the self-terminal device can determine that there is a problem in the terminal device having transmitted the feedback and transmit a response signal to the feedback to the transmitting-side terminal device. Accordingly, the terminal device having received the response signal can display a message indicating a likelihood that there is a cause in the self-terminal device, that is, the transmitting-side terminal device, on the display screen.

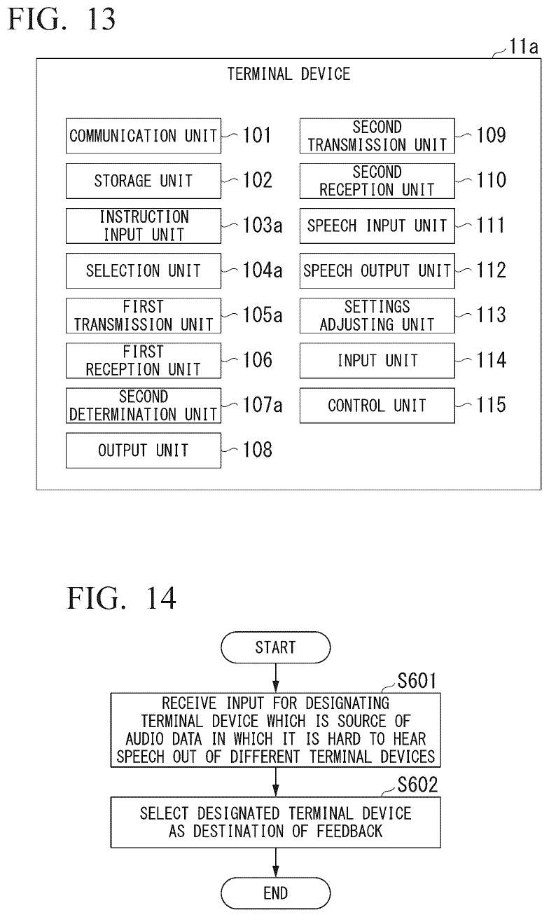

FIG. 13 is a functional block diagram schematically illustrating a configuration of a terminal device which is used in an online conference system according to a third embodiment. The system configuration of the online conference system according to the third embodiment is the same as illustrated in FIG. 1 or 10, except that the functions of each terminal device are the same as the functions of the terminal device illustrated in FIG. 13. FIG. 13 illustrates a configuration of a terminal device 11a as an example, but other terminal devices participating in the same conference room of an online conference in which the terminal device 11a participates have the same functions.

### Third Embodiment

In FIG. 13, the same functions as illustrated in FIG. 2 will be referred to by the same reference signs, and description thereof will be omitted.

In FIG. 13, an instruction input unit 13a receives an instruction indicating speech hard to hear because the audio level of audio data is lower than those of the other terminal devices out of speech output from the speech output unit 112 and an instruction indicating which the terminal device which is a source of the speech hard to hear is. The instruction input unit 13a receives the instruction by receiving an operation input from a participant of the self-terminal device 11a. The instruction input unit 103a may be, for example, at least one of input devices such as a keyboard, a mouse, and a touch panel.

A selection unit 104a selects a terminal device which is a source of speech hard to hear on the basis of the instruction input from the instruction input unit 13a.

A first transmission unit 105a transmits an evaluation result indicating that speech is hard to hear to the terminal device selected by the selection unit 104a.

A second determination unit 107a determines whether there is a cause it is hard to hear speech in the self-terminal device or the terminal device which is a source of the evaluation result on the basis of the received evaluation result.

When a plurality of terminal devices having the same functions as the terminal device 11a are connected to the conference server 20 and an online conference starts such that at least three terminal devices belong to the same conference room, the same processes as Steps S200 to S202 in FIG. 3 are performed in each terminal device.

FIG. 14 is a flowchart illustrating operations of a terminal device. This flowchart is performed after the processes to Step S202 in FIG. 3 have been performed.

Subsequently to Step S202, each terminal device receives an instruction indicating speech hard to hear and an instruction indicating which the terminal device which is a source of the speech hard to hear is on the basis of an instruction from a participant of the self-terminal device (Step S601). A terminal device from which speech hard to hear is transmitted can be designated, and no terminal device is input when speech from all the terminal devices can be heard normally.

The selection unit 104a selects the terminal device selected as a source of the speech hard to hear as a terminal device which is a destination of the feedback on the basis of the instruction input from the instruction input unit 13a (Step S602).

Subsequently to this step, the process flow proceeds to Step S204 in FIG. 3. Accordingly, the first transmission unit 105a can transmit an evaluation result indicating that speech is hard to hear to the terminal device selected as a destination of the feedback.

Then, a dialogue screen for demanding improvement of a speech input function such as a microphone of the self-terminal device is displayed on the terminal device for which the feedback has been received from a plurality of other terminal devices. Accordingly, a participant having ascertained this dialogue screen can review settings associated with the microphone or the like.

On the other hand, when only one terminal device has transmitted the feedback, each terminal device transmits a response signal to the source of the feedback. Accordingly, the dialogue screen for demanding improvement of a speech output function of the self-terminal device is displayed on the terminal device having received the response signal. Accordingly, a participant of the terminal device having received the response signal to the feedback can review settings associated with speech output of the self-terminal device by ascertaining the dialogue screen.

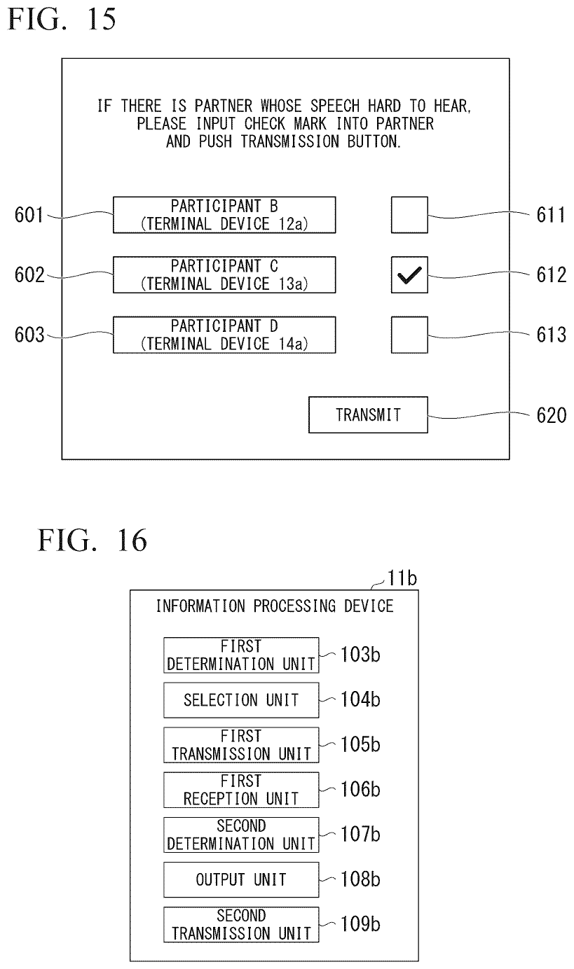

FIG. 15 is a diagram illustrating an example of a display screen which is displayed on the output unit 108 of the terminal device 11a. Names of terminal devices other than the self-terminal device out of the terminal devices participating in the online conference are displayed in parallel on the display screen. Here, names of terminal devices of a participant B (reference sign 601), participant C (reference sign 602), and participant D (reference sign 603) are displayed. An input box is displayed at a position adjacent to the name of each terminal device (reference sign 611, reference sign 612, and reference sign 613). When there is a partner whose speech is hard to hear, a participant of the self-terminal device inputs a check mark to the input box corresponding to the partner. No check mark may be input when there is no partner whose speech is hard to hear, and a check mark may be input to a plurality of terminal devices when there are a plurality of partners. Then, the participant presses a transmission button (reference sign 620) via the input device. Accordingly, the feedback is transmitted to the selected terminal device.

In the third embodiment, an evaluation period may be set, and a cause may be distinguished on the basis of the feedback transmitted in the evaluation period.

According to the third embodiment, since a participant inputs information indicating whether speech of another participant is hard to hear, it is possible to transmit the feedback on the basis of hearing easiness felt by a participant.

According to the first to third embodiments, when a participant with a small opportunity of speech tells “I cannot hear speech” to all the other participants while an online conference proceeds, the other participants may be impressed with unrelated speech, and thus the participant may have difficulty starting speech. Then, the participant may participate in the conference without improving the situation in which it is hard to hear speech. On the other hand, according to the aforementioned embodiments, since a participant does not need to inform the other participants that it is hard to hear speech, it is possible to reduce a burden on the participant.

When a certain participant out of a plurality of participants participating in an online conference feels speech of the other participants to be small, the participant may resolve hardness to hear speech by increasing the sound volume of the terminal device used by the participant.

However, when a participant feels speech of a specific participant out of a plurality of other participants to be large and feels sound of the other participants to be small and intends to increase the sound volume according to the specific participant whose speech sound is small, the sound volumes of the speech of the participants whose speech sound is large, and thus a more increase of the sound volume is limited. In this case, speech of a participant with a small sound volume cannot be necessarily heard. In this way, when there is unevenness in a sound volume between a plurality of participants participating in an online conference, it may be difficult to hear speech of at least some participants.

On the other hand, according to the first to third embodiments, when a certain participant speaks or does not speak and there is unevenness in audio level between a plurality of other participants, it is possible to determine on which of a participant side speaking and a participant side hearing speech contents there is a cause of the unevenness and to transmit a message for removing the unevenness to a terminal device of the participant side based on the determination result. Accordingly, it is possible to take measures for resolving the cause by causing the participant to ascertain the message.

### Fourth Embodiment

FIG. 16 is a block diagram schematically illustrating a configuration of an information processing device 11b that is used in an online conference system according to a fourth embodiment.

The information processing device 11b is an information processing device that is used by a participant, and the information processing device is communicatively connected to a conference server to serve as a part of a conference system.

A first determination unit 103b makes a comparison between an audio level of audio data based on speech contents which are transmitted from at least two information processing devices other than the self-information processing device and a determination criterion. A selection unit 104b selects an information processing terminal which is a source of audio data of which the audio level has not reached a criterion on the basis of the result of determination. A first transmission unit 105b transmits an evaluation result indicating that the audio level has not reached the criterion to the selected information processing terminal. A first reception unit 106b receives the evaluation result from information processing devices other than the self-information processing device. A second determination unit 107b determines whether there is a cause the audio level has not reached the criterion in the self-information processing device or an information processing device which is a source of the evaluation result on the basis of the received evaluation result.

An output unit 108b outputs a notification indicating that there is a cause in the self-information processing device to the self-information processing device when it is determined on the basis of the result of determination from the second determination unit 107b that there is a cause in the self-information processing device. When it is determined on the basis of the result of determination from the second determination unit 107b that there is not a cause in the self-information processing device, a second transmission unit 109b transmits a notification indicating that there is a cause in the information processing device which is a source of the evaluation result to the information processing device which is the source.

In the first to fourth embodiments, the selection unit 104, the selection unit 104a, the first transmission unit 105, the first transmission unit 105a, the first reception unit 106, the second determination unit 107, the second determination unit 107a, the second transmission unit 109, the second reception unit 110, the settings adjusting unit 113, and the control unit 115 are provided in each terminal device. However, at least one function of these functions may be provided in the conference server 20. One function of these functions may be realized by cooperation of a terminal device and the conference server 20.

The functions of the terminal device in FIG. 1 may be realized by recording a program for realizing the functions on a computer-readable recording medium and causing a computer system to read and execute the program recorded on the recording medium. The “computer system” mentioned herein includes an OS or hardware such as peripherals.

The “computer system” may include a homepage provision environment (or display environment) when a WWW system is used.

The “computer-readable recording medium” is a portable medium such as a flexible disk, a magneto-optical disc, a ROM, or a CD-ROM or a storage device such as a hard disk incorporated into a computer system. The “computer-readable recording medium” may include a medium that holds a program for a predetermined time such as a nonvolatile memory in a computer system serving as a server or a client. The program may be a program for realizing some of the aforementioned functions or may be a program for realizing the aforementioned functions in combination with another program stored in advance in the computer system. The program may be stored in a predetermined server, and the program may be delivered (downloaded or the like) via a communication line in response to a request from another device.

While embodiments of the present invention have been described above in detail with reference to the drawings, any specific configuration is not limited to these embodiments and includes designs or the like without departing from the gist of the invention.

### REFERENCE SIGNS LIST

11 Terminal device
11a Terminal device
11b Information processing device
12 Terminal device
13 Terminal device
14 Terminal device
20 Conference server
101 Communication unit
102 Storage unit
103 First determination unit
103a Instruction input unit
103b First determination unit
104 Selection unit
104a Selection unit
104b Selection unit
105 First transmission unit
105a First transmission unit
105b First transmission unit
106 First reception unit
106b First reception unit
107 Second determination unit
107a Second determination unit
107b Second determination unit
108 Output unit
108b Output unit
109 Second transmission unit
109b Second transmission unit
110 Second reception unit
111 Speech input unit
112 Speech output unit
113 Settings adjusting unit
114 Input unit
115 Control unit
202 Storage unit

What is claimed is:

1. An information processing device communicatively connectable with a conference system, the information processing device being configured to be used by a conference participant, the information processing device comprising:
a first determination unit configured to determine audio levels of audio data based on speech contents which are respectively transmitted from at least two different information processing devices, all of which which are different from and other than the information processing device;
a selection unit configured to select an information processing terminal which is a source of audio data of which the audio level has not reached a criterion on the basis of a result of determination;
a first transmission unit configured to transmit an evaluation result indicating that the audio level has not reached the criterion to the information processing terminal selected;
a first reception unit configured to receive the evaluation result from the different information processing devices other than the information processing device;
a second determination unit configured to determine whether there is a cause that the audio level has not reached the criterion in the information processing device or another information processing device which is a source of the evaluation result on the basis of the evaluation result received; and
an output unit configured to notify, to the information processing device, a notification indicating that there is a cause in the information processing device in case that it is determined, on the basis of the result of determination made by the second determination unit, that there is the cause in the information processing device.

2. The information processing device according to claim 1, further comprising:
a second transmission unit configured to transmit a notification indicating that there is a cause in the information processing device which is the source of the evaluation result into the information processing device which is the source when it is determined on the basis of the result of determination from the second determination unit that there is not a cause in the information processing device.

3. The information processing device according to claim 1, further comprising:
a second reception unit configured to receive a notification transmitted from an information processing device other than the information processing device,
wherein the output unit outputs a notification indicating that there is a cause in a sound collecting function in the information processing device on the basis of the received notification.

4. The information processing device according to claim 3, wherein the first determination unit is configured to calculate a difference between the audio levels of audio data transmitted respectively from the at least two different information processing devices different from and other than the information processing device on the basis of the audio levels of audio data received from the at least two different information processing devices which are different from and other than the information processing device, and the first determination unit is configured to make a comparison between the calculated difference and a reference value, and
wherein the selection unit is configured to select, as a transmission destination, the information processing device which is a source of audio data of which the audio level is lower in a combination in which the difference in audio level based on the comparison result is equal to or greater than the reference value.

5. The information processing device according to claim 3, wherein the first determination unit is configured to compare, with reference to a predetermined reference value, the audio levels of audio data transmitted from the at least two different information processing devices which are different from and other than the information processing device, and
wherein the selection unit is configured to select, as a transmission destination, the information processing device which is a source of audio data of which the audio level is determined to be less than the reference value on the basis of the comparison result.

6. The information processing device according to claim 4, wherein the first determination unit is configured to compare the audio levels of audio data based on speech contents in a predetermined period of past time from a determination target time.

7. The information processing device according to claim 6, wherein the first determination unit is configured to calculate a respective average value of the audio levels for each source of audio data based on the speech contents in the predetermined period of past time and the first determination unit is configured to compare the audio levels using the respective average values calculated.

8. The information processing device according to claim 1, wherein the audio level is a magnitude of the audio amplitude.

9. An information processing device communicatively connectable with a conference system, the information processing device being configured to be used by a conference participant, the information processing device comprising:
a speech output unit configured to output speech according to audio data based on speech contents which are transmitted from at least two different information processing devices which are different from and other than the information processing device;
an instruction input unit configured to receive a first instruction indicating sound which is hard to hear due to a lower audio level of audio data than that of other information processing devices out of speech output from the speech output unit, and to receive a second instruction indicating which of the information processing devices a source of the speech hard to hear is;
a selection unit configured to select an information processing terminal which is the source of the speech hard to hear on the basis of the first and second instructions received;
a first transmission unit configured to transmit an evaluation result indicating that speech is hard to hear to the information processing terminal selected;
a first reception unit configured to receive the evaluation result from a different information processing device which is different from and other than the information processing device;
a second determination unit configured to determine whether there is a cause the speech is hard to hear in the information processing device or the different information processing device which is a source of the evaluation result on the basis of the evaluation result received; and
an output unit configured to notify, to the information processing device, a notification indicating that there is a cause in the information processing device in case that it is determined, on the basis of the result of determination made by the second determination unit, that there is the cause in the information processing device.

10. A conference system to which an information processing device usable by a participant is communicatively connectable, the conference system comprising:
a first determination unit configured to determine audio levels of audio data based on speech contents which are respectively transmitted from at least two different information processing devices, all of which which are different from and other than the information processing device;
a selection unit configured to select an information processing terminal which is a source of audio data of which the audio level has not reached a criterion on the basis of a result of determination;
a first transmission unit configured to transmit an evaluation result indicating that the audio level has not reached the criterion to the information processing terminal selected;
a first reception unit configured to receive the evaluation result from the different information processing devices other than the information processing device;
a second determination unit configured to determine whether there is a cause that the audio level has not reached the criterion in the information processing device or another information processing device which is a source of the evaluation result on the basis of the evaluation result received; and
an output unit configured to notify, to the information processing device, a notification indicating that there is a cause in the information processing device in case that it is determined, on the basis of the result of determination made by the second determination unit, that there is the cause in the information processing device.

11. An information processing method in a conference system to which an information processing device usable by a participant is communicatively connectable, the information processing method comprising:
determining audio levels of audio data based on speech contents which are respectively transmitted from at least two different information processing devices, all of which which are different from and other than the information processing device;
selecting an information processing terminal which is a source of audio data of which the audio level has not reached a criterion on the basis of a result of determination;
transmitting an evaluation result indicating that the audio level has not reached the criterion to the information processing terminal selected;
receiving the evaluation result from the different information processing devices other than the information processing device;
determining whether there is a cause that the audio level has not reached the criterion in the information processing device or another information processing device which is a source of the evaluation result on the basis of the evaluation result received; and
notifying, to the information processing device, a notification indicating that there is a cause in the information processing device in case that it is determined, on the basis of the result of determination made by the second determination unit, that there is the cause in the information processing device.
